(19) United States
(12) Patent Application Publication
(10) Pub. No.: US 2016/0328520 A1
(43) Pub. Date: Nov. 10, 2016

(54) COMPUTER IMPLEMENTED METHODS, SYSTEMS AND FRAMEWORKS CONFIGURED FOR FACILITATING PRE-CONSULTATION INFORMATION MANAGEMENT, MEDICATION-CENTRIC INTERVIEW PROCESSES, AND CENTRALIZED MANAGEMENT OF MEDICAL APPOINTMENT DATA

(71) Applicant: DOCTORHX PTY LTD, Burwood, New South Wales (AU)

(72) Inventors: Ron GRANOT, Sydney (AU); Harry COUSENS, Sydney (AU)

(21) Appl. No.: 15/109,610

(22) PCT Filed: Dec. 24, 2014
(86) PCT No.: PCT/AU2014/001166

§ 371 Date: Jul. 1, 2016

(30) Foreign Application Priority Data
Jan. 3, 2014 (AU) 2014900011
Jan. 3, 2014 (AU) 2014900012
Jan. 3, 2014 (AU) 2014900014
Jan. 3, 2014 (AU) 2014900016
Jan. 3, 2014 (AU) 2014900017
Jan. 3, 2014 (AU) 2014900018

(51) Int. Cl. G06F 19/00; G06F 17/30

(52) U.S. Cl. CPC G06F 19/322; G06F 17/30477; G06F 19/3456

(57) ABSTRACT

Computer implemented methods, systems and frameworks are described for facilitating pre-consultation information management Embodiments described are intended to operate in the context of a pre-consultation interview between a “user” and a “consultant”. The user operates a computing device to interact with a computer-delivered interface. This interface may serve a range of purposes, including the conducting of a pre-consultation interview and the booking of an appointment. The pre-consultation interview obtains, from the user, various aspects of personal information relevant to a proposed consultation This information is transformed into form appropriate for a consultant. This may include the generation of a technical brief and/or data for integration into a consultant's electronic data management systems. The pre-consultation interview may provide a translation mechanism between language used by the general public, and technical language preferred by a consultant. This translation may extend beyond “layman's terms to technical language”, and optionally include translation between foreign languages.

### FIELD OF THE INVENTION

The present invention relates to computer implemented methods, systems and frameworks configured to provide functionalities including facilitating pre-consultation information management, medication-centric interview processes, and centralized management of medical appointment data. Embodiments have been particularly developed for application in the context of healthcare services. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

There are a number of industries in which consultants experience challenges in efficiently conducting appointments with clients. This often causes appointments to run beyond their scheduled finishing times, delaying subsequent appointments in a cascading and compounding fashion. There is a need in the art for technology which can assist in reducing such problems.

### SUMMARY OF THE INVENTION

It is an object of the present invention to overcome or ameliorate at least one of the disadvantages of the prior art, or to provide a useful alternative.

One embodiment provides a computer implemented method for obtaining medical information from a user, the method including:

accepting, from the user, data indicative of a medication;

accessing an information repository thereby to determine a plurality of medical problems treated by the medication;

enabling the user to select one of the determined medical problems based on a non-technical problem description; and

based on the user's selection of one of the determined medical problems, enabling the user to select further detailed information specific to that medical problem and then updating a database that maintains records of the user's medical history to reflect the medication and selected medical problem.

One embodiment provides a computer implemented method for obtaining medical information from a user, the method including:

accepting, from the user, data indicative of a medication;

accessing an information repository thereby to determine a plurality of medical problems treated by the medication;

enabling the user to select one of the determined medical problems; and

generating a technical brief including details of the medication and a technical problem description for the selected one of the medical problems.

One embodiment provides a computer implemented method for obtaining medical information from a user, the method including:

(i) accepting, form the user, data indicative of a medication;

(ii) accessing an information repository thereby to determine a plurality of medical problems treated by the medication;

(iii) enabling the user to select one of the determined medical problems;

(iv) enabling the user to select appropriate associated information about these problems; and

(v) generating a technical brief including details of the medication and a technical problem description for the selected one of the medical problems.

One embodiment provides a computer implemented method including repeating (i) to (iv) for a plurality of medications, wherein the technical brief including details of the plurality of medications and technical problem descriptions for the respective selected medical problems.

One embodiment provides a computer implemented method including, based on the selected one of the determined medical problems, presenting to the user a series of interview stimuli defined by a template associated with the determined medical problem.

One embodiment provides a computer implemented method further including maintaining a central data record for the user, the central data record including details of medications and technical problems selected by the user.

One embodiment provides a computer implemented method wherein (iii) includes enabling the user to select one of the determined medical problems based on a non-technical problem description.

One embodiment provides a computer implemented method including querying one or more information repositories that collectively map medications to (a) medical problems based on technical descriptions and (b) medical problems based on non-technical problem descriptions.

One embodiment provides a computer implemented method wherein the technical brief is defined by a string of sentences in a selected language.

One embodiment provides a computer implemented method for facilitating pre-consultation information management, the method including:

(i) providing an interview interface configured to receive input data from a user in response to an interview process, wherein the interface is configured to deliver interview stimuli to the client;

(ii) operating an interview driving module thereby determine a sequence of interview stimuli to be delivered via the interface, wherein the sequence is affected by one or more responses received in respect of preceding interview stimuli;

(iii) maintaining a set of user response data derived from responses to the interview stimuli; and

(iv) processing the received user response data thereby to generate a technical brief, wherein the technical brief includes a string of sentences defined based upon the received user response data.

One embodiment provides a computer implemented method wherein the interview interface is additionally configured to enable the user to select a consultant from a predefined list of consultants.

One embodiment provides a computer implemented method wherein the interview interface is additionally configured to enable the user to book an appointment with a selected consultant.

One embodiment provides a computer implemented method including operating an appointment booking module, wherein the appointment booking module is configured to interact with a plurality of consultant-side appointment management software modules respectively operated by the plurality of consultants.

One embodiment provides a computer implemented method including determining communications data associated with a selected consultant, and delivering the generated technical brief to the selected consultant in accordance with the communications data.

One embodiment provides a computer implemented method wherein the sequence of interview stimuli is delivered via a plurality of looped processes.

One embodiment provides a computer implemented method wherein one or more of the looped processes implements, on a given loop, a template-derived set of interview stimuli.

One embodiment provides a computer implemented method for facilitating pre-consultation information management, the method including:

(i) providing an interview interface configured to receive input data from a user in response to an interview process, wherein the interface is configured to deliver interview stimuli to the client;

(ii) operating an interview driving module thereby determine a sequence of interview stimuli to be delivered via the interface, including:

(a) presenting a looped symptom-centric interview process thereby to enable the user to input data indicative of symptoms to be discussed at an appointment;

(b) presenting a looped medication-centric interview process, thereby to enable the user to input data indicative of medications used by the user; and

(c) presenting a looped problem-centric interview process, thereby to enable the user to input data indicative of medical problems experienced by the user; and

(iii) maintaining a set of user response data derived from responses to the interview stimuli.

One embodiment provides a computer implemented method including processing the received user response data thereby to generate a technical brief, wherein the technical brief includes a string of sentences defined based upon the received user response data.

One embodiment provides a computer implemented method wherein the symptom-centric interview process is responsive to input indicative of a symptom for identifying a set of interview stimuli associated with that symptom.

One embodiment provides a computer implemented method wherein the problem-centric interview process is responsive to input indicative of a problem for identifying a set of interview stimuli associated with that problem.

One embodiment provides a computer implemented method wherein the problem-centric interview process, for at least a first set of one or more loops, prompts the user to input data indicative of medical problems identified via the medication-centric interview process.

One embodiment provides a computer implemented method for enabling booking of appointments with consultants, the method including:

(i) providing an interface configured to receive input data from a user indicative of desired consultant selected from a list of available consultants;

(ii) accessing a database that associates the available consultants with respective booking protocols;

(iii) determining, based on the database, the booking protocol associated with the desired consultant;

(iv) submitting a query, using the determined booking protocol, thereby to determine one or more available appointment times for the desired consultant;

(v) enabling the user to book one of the available appointment times; and

(vi) responsive to the user booking one of the available appointment times, providing a signal in accordance with the determined booking protocol thereby to book the appointment in an information system associated with the desired consultant.

One embodiment provides a computer implemented method wherein the plurality of booking protocols are configured to enable integration with a respective plurality of consultant-side appointment management software modules respectively operated by the plurality of consultants.

One embodiment provides a computer implemented method wherein the user is presented with an interface thereby to undertake a pre-consultation interview process for the appointment.

One embodiment provides a computer implemented method wherein each booking protocol defines rules for determining availability for the associated consultant and booking an appointment with the selected consultant.

One embodiment provides a computer implemented method wherein for at least one booking protocol, one or more appointment times are booked when checking availability thereby to prevent booking of those appointment times for a predetermined period, and subsequently cancelling some or all of the booked appointment times.

One embodiment provides a computer implemented method for facilitating pre-consultation information management, the method including:

(i) providing an interface configured to receive input data from a user in response to an interview process, wherein the interface is configured to deliver interview stimuli to the user in a first language;

(ii) operating an interview driving module thereby determine a sequence of interview stimuli to be delivered via the interface;

(iii) maintaining a set of user response data derived from responses to the interview stimuli; and

(iv) identifying a consultant selected by the user, wherein the consultant is associated with a second language foreign with respect to the first language;

(v) processing the received user response data based on a template specific to the second language thereby to generate a technical brief, wherein the technical brief includes a string of sentences in the second language defined based upon the received user response data.

One embodiment provides a computer implemented method wherein the interview stimuli delivered in the first language relate to medical conditions affecting the user.

One embodiment provides a computer implemented method wherein the first language one of a plurality of available first languages.

One embodiment provides a computer implemented method wherein a user selects a desired first language from the plurality of available first languages.

One embodiment provides a computer implemented method wherein the second language one of a plurality of available second languages with which the consultant is able to be associated.

One embodiment provides a computer implemented method for facilitating management of user medical information, the method including:

(i) providing an interview interface configured to receive input data from a user in response to an interview process, wherein the interface is configured to deliver interview stimuli to the client;

(ii) operating an interview driving module thereby determine a sequence of interview stimuli to be delivered via the interface;

(iii) maintaining, for each of a plurality of users, a respective medical history data set derived from that user's responses to the interview stimuli via one or more individual interview sessions;

(iv) enabling a given user to book an appointment with a selected one of a plurality of medical practitioners; and

(v) in respect of a given booked appointment, providing, to the selected medical practitioner, a technical brief derived from the given user's medical history data.

One embodiment provides a computer implemented method wherein the interview interface is additionally configured to enable the user to select a consultant from a predefined list of consultants.

One embodiment provides a computer implemented method wherein the interview interface is additionally configured to enable the user to book an appointment with a selected consultant.

One embodiment provides a computer implemented method including operating an appointment booking module, wherein the appointment booking module is configured to interact with a plurality of consultant-side appointment management software modules respectively operated by the plurality of consultants.

One embodiment provides a computer implemented method including determining communications data associated with a selected consultant, and delivering the generated technical brief to the selected consultant in accordance with the communications data.

One embodiment provides a computer implemented method wherein the sequence of interview stimuli is delivered via a plurality of looped processes.

One embodiment provides a computer implemented method wherein one or more of the looped processes implements, on a given loop, a template-derived set of interview stimuli.

One embodiment provides a computer implemented method for facilitating management of user information, the method including:

(i) providing an interview interface configured to receive input data from a user in response to an interview process, wherein the interface is configured to deliver interview stimuli to the client;

(ii) operating an interview driving module thereby determine a sequence of interview stimuli to be delivered via the interface;

(iii) maintaining, for each of a plurality of users, a respective user information history data set derived from that user's responses to the interview stimuli via one or more individual interview sessions;

(iv) enabling a given user to book an appointment with a selected one of a plurality of consultants; and

(v) in respect of a given booked appointment, providing, to the selected consultant, a technical brief derived from the given user's user information history data.

One embodiment provides a computer implemented method wherein the interview interface is additionally configured to enable the user to select a consultant from a predefined list of consultants.

One embodiment provides a computer implemented method wherein the interview interface is additionally configured to enable the user to book an appointment with a selected consultant.

One embodiment provides a computer implemented method including operating an appointment booking module, wherein the appointment booking module is configured to interact with a plurality of consultant-side appointment management software modules respectively operated by the plurality of consultants.

One embodiment provides a computer implemented method including determining communications data associated with a selected consultant, and delivering the generated technical brief to the selected consultant in accordance with the communications data.

One embodiment provides a computer implemented method wherein the sequence of interview stimuli is delivered via a plurality of looped processes.

One embodiment provides a computer implemented method wherein one or more of the looped processes implements, on a given loop, a template-derived set of interview stimuli.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1A schematically illustrates a framework according to one embodiment.

FIG. 1B schematically illustrates a framework according to one embodiment.

FIG. 1C schematically illustrates a framework according to one embodiment.

FIG. 2A illustrates a method according to one embodiment.

FIG. 2B illustrates a method according to one embodiment.

FIG. 2C illustrates a method according to one embodiment.

FIG. 2D illustrates a method according to one embodiment.

FIG. 2E illustrates a method according to one embodiment.

FIG. 2F illustrates a method according to one embodiment.

FIG. 3 illustrates an exemplary client/server arrangement.

FIG. 4A schematically illustrates data handling processes.

FIG. 4B schematically illustrates data handling processes.

### DETAILED DESCRIPTION

Described herein are computer implemented methods, systems and frameworks configured for facilitating pre-consultation information management, along with embodiments that extend beyond that area of application. Various embodiments described herein are intended to operate in the context of a pre-consultation interview arrangement, in relation to a proposed consultation between a “user” and a “consultant”. The user operates a computing device (for example a PC, laptop, notebook, tablet, smartphone, PDA or the like) thereby to interact with a computer-delivered interface. This interface may serve a range of purposes, with major examples considered herein including the conducting of a pre-consultation interview and the booking of an appointment. The pre-consultation interview obtains, from the user, various aspects of personal information relevant to a proposed consultation (and relevant to the user generally). This information is then transformed into form appropriate for a consultant. For example, this may include the generation of a technical brief and/or data for integration into a consultant's electronic data management systems. In some cases the pre-consultation interview provides a translation mechanism between language conventionally used by the general public, and technical language preferred by a consultant. This translation may extend beyond “layman's terms to technical language”, and optionally include translation between foreign languages.

Embodiments described below tend to focus on application of the technology to a healthcare environment, whereby the users are patients (and/or potential patients) and the consultant is a medical professional (for example a general practitioner, physiotherapist, specialist, or the like). In spite of this, it should be appreciated at all times that further embodiments are applicable in other contexts, for example where consultants operate in fields such as law, accounting, photography, hair/beauty, personal training, and so on.

### Exemplary Frameworks

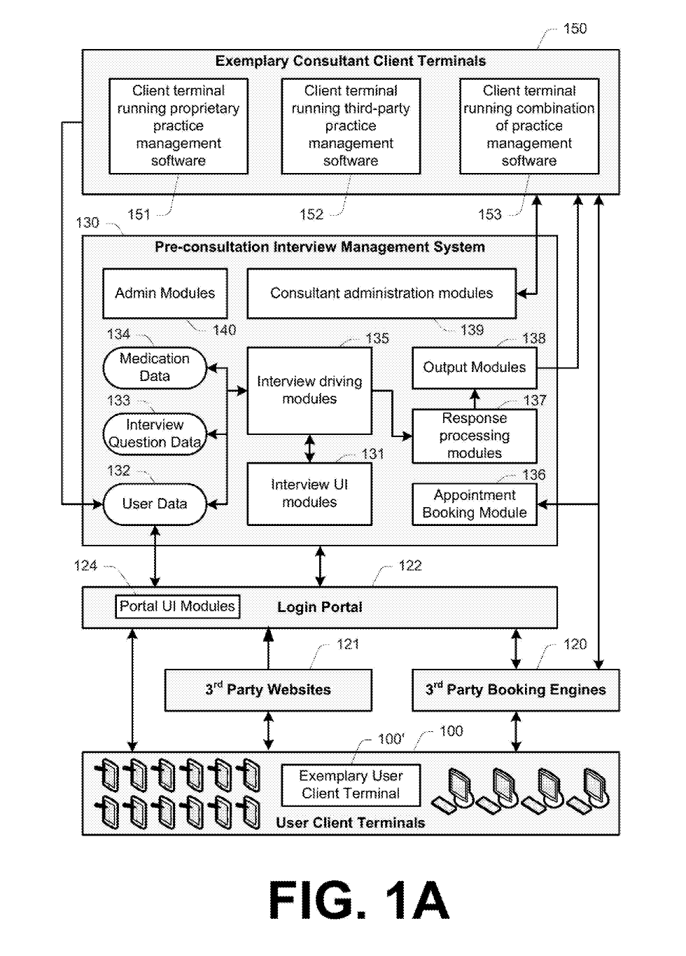

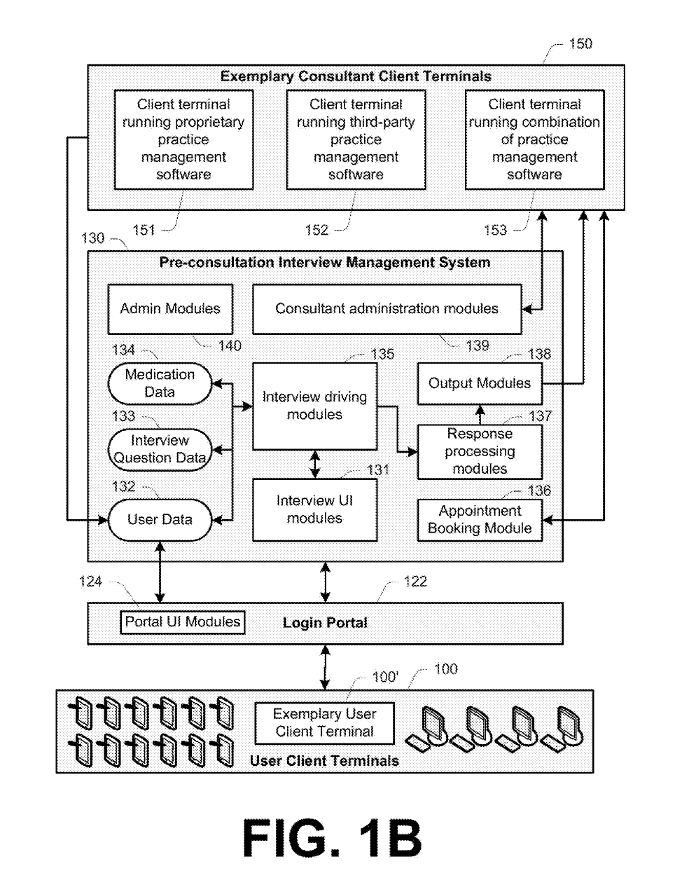

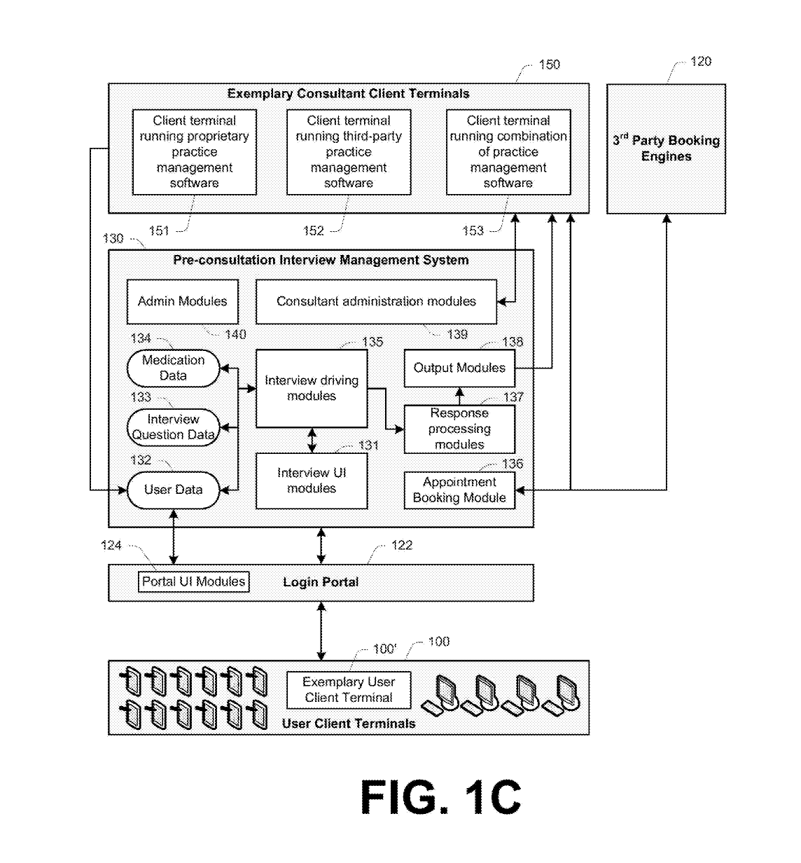

FIG. 1A, FIG. 1B and FIG. 1C illustrate exemplary frameworks according to various embodiments. It will be appreciated that various further variations (for example in the context of adding, removing and/or modifying components) may be made to these examples, thereby to provide further embodiments. The description below focuses primarily on FIG. 1A, which illustrates a more comprehensive selection of components, features and functionalities.

Block 100 represents user client terminals, which may include PCs, notebooks, tablets, smartphones and so on. In overview, substantially any device capable of displaying a user interface (with via a local app or web browser) with capability to externally transfer data may be appropriate to operate as a user client terminal in this context. An exemplary client terminal 100′ takes the form of a web-enabled computing device, having a processor, memory (that maintains software instructions executable via the processor) and a communications module that is configured to access a network (preferable the Internet).

For the sake of this example, each client terminal 100 is operated by a respective, being patients and/or prospective patents (i.e. persons wishing to engage in a consultation with a consultant in the form of a medical professional. In some cases one or more of the client terminals are operated by representatives of patients and/or prospective patients (for example parents and the like). In some cases the client terminals belong to the patients, and are used for purpose described herein at locations of the users' choosing. However, in other cases the terminals are supplied by consultants, for example in a reception, triage, and/or waiting room location for use by users at that location and may be operated by the consultant's staff (for example receptionist, practice nurse and the like).

Block 130 represents a pre-consultation interview management system. This may be defined in practice by a range of distributed computing components, for example a plurality of distributed networked servers or the like. System 130, in the illustrated embodiment, allows users of client terminals 100 to access functionalities including participation in pre-consultation interviews, and booking of appointments. These functionalities are discussed in more detail below. In some embodiments this includes accessing user interface components made available vie one or more web servers, and rendering data indicative of those user interface components in a local web browser application executing at a client terminal. In other embodiments a proprietary app is used as an alternative to a web browser, and in such cases software instructions (i.e. computer executable code) defining some or all of the user interface components are stored locally at the client terminal.

Users of client terminal 100 access system 130 via a login portal 122. This may be accessed directly (as is the preferred scenario), or as via various third party websites 121 or third party booking engines 120. In any event, login portal 122 is associated with user interface modules 124 which enable a user to login (via provision of credentials corresponding to an account defined in a user database 132) and/or register (via submission of personal information, used to define an account in user database 132). This allows individual unique verification of each user of a client terminal 100 prior to their accessing of functionalities provided by system 130.

In some cases a user accesses the login portal via direct web navigation. In some cases, a consultant or consultant organisation sends a hyperlink (for example via email) to a known user, thereby to assist in such navigation. In such cases the hyperlink preferably pre-populates certain aspects of user registration data with details specific to the consultant or consultant organisation. For example, in some embodiments each user is associated with a specific medical practice.

System 130 provides interview UI modules, which enable an interview process to be delivered to a client terminal (either via a browser based arrangement or via a proprietary app). This is, in overview, a process whereby various stimuli (for example questions and associated user interface components) are presented to a user, thereby to procure response data from the user. An interview driving module 135 provide the underlying logic that drives the interview process, for example in terms of question selection and/or ordering. This is discussed in additional detail further below. In this embodiment interview driving modules 135 operate in conjunction with a number of databases, including:
User data 132, which may include historical user data.
Interview question data 133, which includes data indicative of questions that are asked based on the logic of module 135.
Medication data 134, which preferably provides (or is associated with) a translation mechanism between plain language condition descriptions and medical terminology (discussed in more detail further below).

Based on a user's interaction with interview UI modules 131 (i.e. response data), a set of intermediate data is defined. This is passed to response processing modules 137, which process the response data thereby to define data in a form suitable for external transmission via output modules 138. For example, in some embodiments one of response processing modules 137 applies a predefined algorithm thereby to automatically generate a technical brief for a consultant (for example a medical consultant in the preferred embodiment). Other modules may perform processes such as defining data packages for delivery to data management systems, and so on.

Output modules 138 transmit data indicative of the brief to consultant client terminals, for example via email, or via software integration. Fax transmissions may also be used.

It will be appreciated that the nature of output modules 138 depends heavily on the nature of components receiving outputted data. In the context of FIG. 1A, output modules 138 are configured to deliver data to consultant client terminals 150, being computing devices operated by/for consultants (such as medical professionals). Three categories of exemplary consultant client terminals are considered in the context FIG. 1A:
A client terminal 151 which runs proprietary practice management software. This practice management software is “proprietary” in the sense that it is specifically tailored for integration with system 130. Output modules 138 are preferably configured to address data packages directly to such software applications, such that output is seamlessly received and applied in the practice management software.
A client terminal 152 which runs third party practice management software. This EMR software is “third party” in the sense that it is provided via a party other than that which provides system 130, and is not specifically tailored for integration with system 130. In such cases, the output might not be inherently/automatically able to be applied to all third party software, and hence may be communicated via more conventional means such as email or the like. In some cases, third party software makes available an API such that output modules 138 are able to provide data the software application in a manner acceptable to the software application.
A client terminal 152 which runs a combination of proprietary practice management software third party practice management software. For example, this may include a piece of third party software operating in conjunction with a piece of proprietary software (for example a plug-in or other integration enabler) which allows data provided by output modules 138 to be functionally integrated into the third party software. This also includes situations where a first piece of software (optionally proprietary or third party) is used for one purpose (such example appointment booking) and another piece of software (optionally third party or proprietary) is used for another purpose (such as maintaining information regarding patients/customers or the like).

In the context of application for medical professionals, the software executed by consultant client terminals typically includes EMR software (Electronic Medical Record software). Examples of such software include MediTouch, Kareo, Medios, WebPT, Centricty, and the like.

An appointment booking module 136 enables booking of appointments with consultants via system 130. This is configured to integrate with a range of third party booking software modules, including but not limited to booking modules provided in practice management software executing at client terminals 150. In overview, booking module 136 enables the making of bookings via system 130 with a range of consultants independent of their preferred (or existing) booking systems.

Functional block 132 represents administration modules that enable consultants to register, control their settings, update their details, and so on. For example, these allow consultants to register to use system 130, update their details/preferences, and so on. Functional block 140 represents general administration modules, for example to enable modification of interview driving modules, system rules, and so on.

### Exemplary Patient Interview Flow Process

Described below is a path through an exemplary patient interview process, described by reference to a medical application of system 130. It will be appreciated that this is an example only, and that variations may be made to this process. For example, various steps may be re-ordered, modified, and so on.

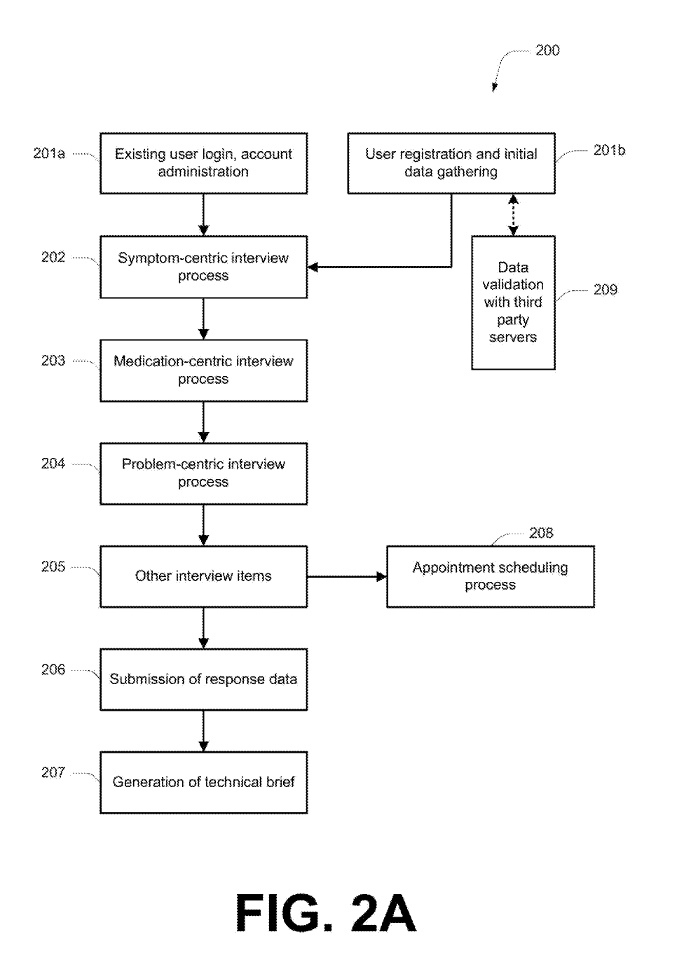

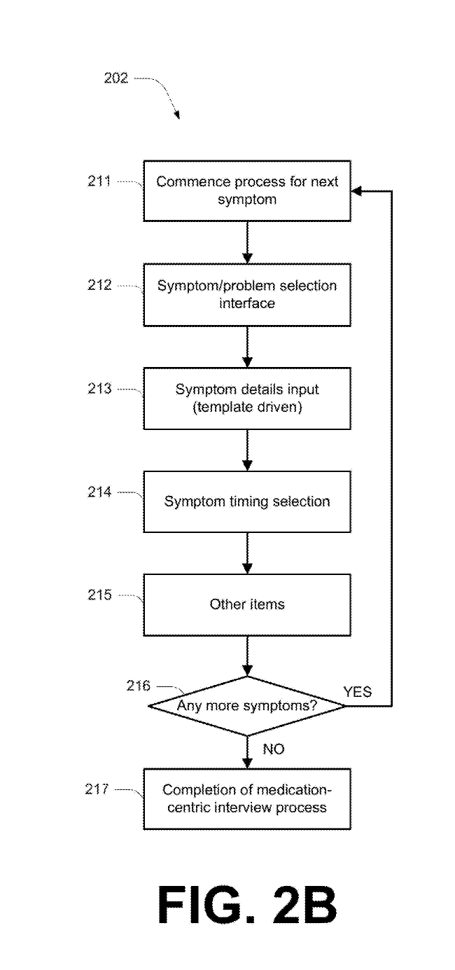

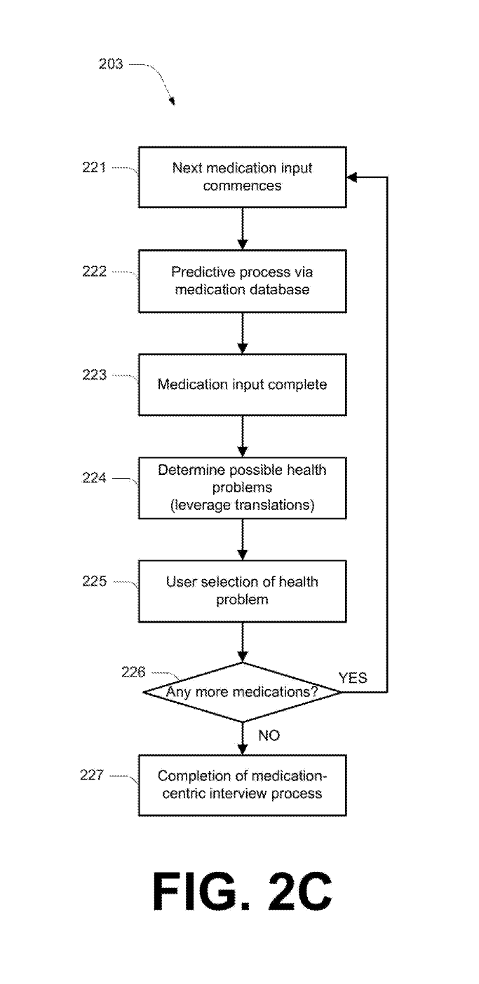

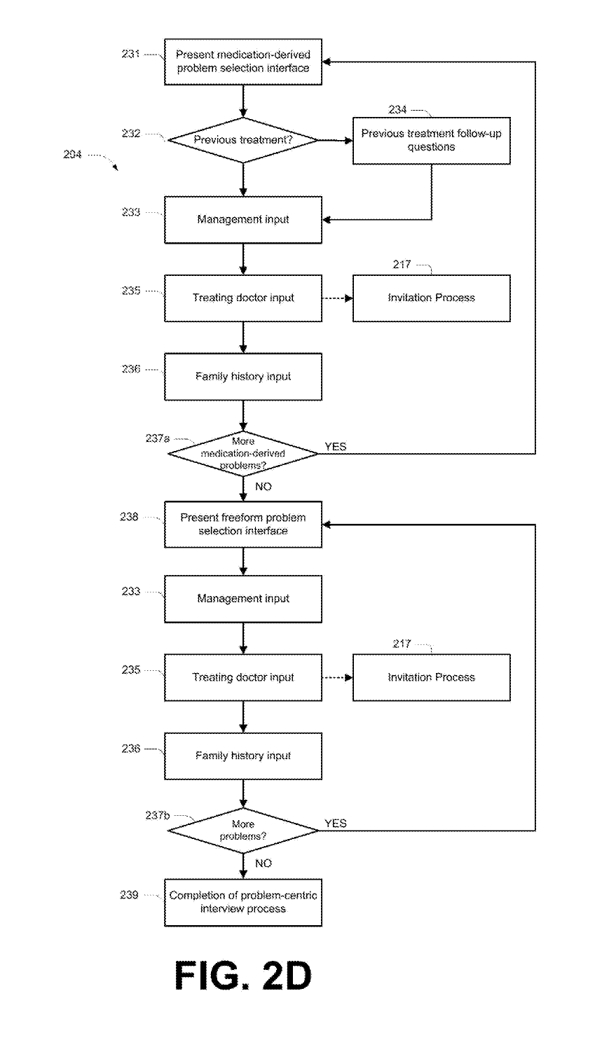

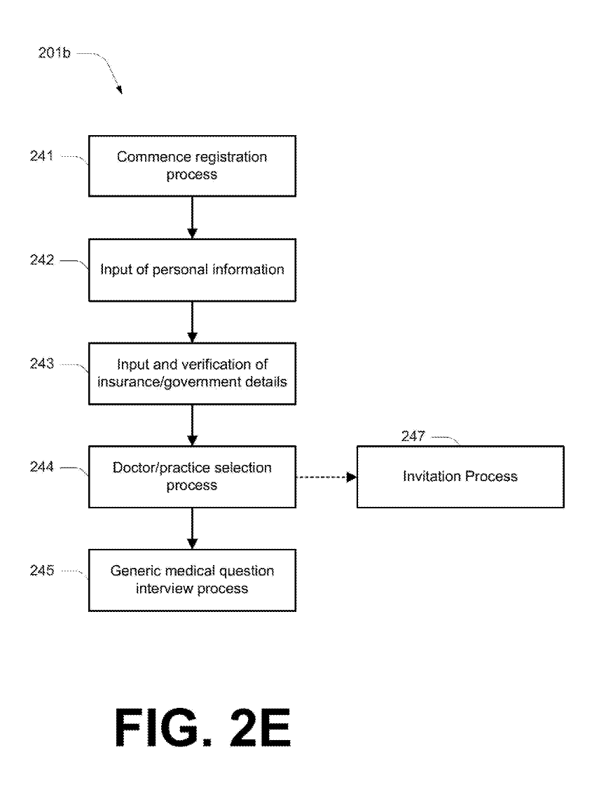

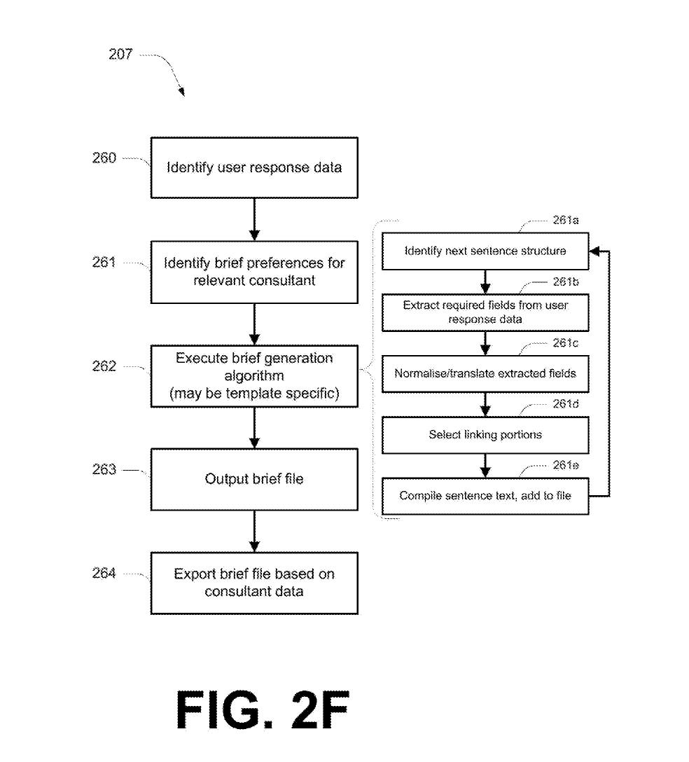

FIG. 2A illustrates a method 200 according to one embodiment. Various individual functional blocks, of subsets of functional blocks, are also considered to form embodiments. In this regard method 200 provides an overview of an interview process, in this case being a patient interview process in the context of a medical appointment. As noted, in other examples the technology described herein is implemented outside of the medical field, and it will be appreciated how the example of FIG. 2A is able to be adapted to such other implementations. Method 200, in general terms, describes an interactive process via a web-based interface (or app-based interface) which allows communication between a user and system 130 (and/or login portal 122).

Block 201a represents a login process for an existing user (pre-registered) of system 130 (for instance based on a username/password input procedure), and provides access to various account administration procedures. For example, this may include modification of personal details, updating preferences, and so on.

Block 201b represents a user registration and initial data gathering process, for users who are not yet registered to use system 130. This, in the illustrated embodiment, includes a data validation process 209 whereby inputted details are verified with third party sources. For example, healthcare and/or insurance data may be inputted at 201b, and verified at 209. This may include, in the context of Australia, Medicare details.

As context, patients are enabled to register on the site, in which they will be asked a series of questions about their medical history (for example allergies, family history, etc). The user is also prompted to search and select a doctor (or in some cases medical facility) by using a locator function, and adds such relevant doctors to their electronic ‘file’. Users are, in some embodiments, might also be directed to a registration web page via a hyperlink (for example email an invitation with a link to register, or a hyperlink in a doctor's own webpage). In such cases the process of selecting a doctor is automated, based on data in the hyperlink which enables automated identification of the inviting doctor.

In some embodiments, during initial registration, each user will be asked to find and select a doctor/practice in which they wish to join (unless automatically directed by a hyperlink or the like). Once this is completed, they will then be able to make an appointment at the relevant practice, and which is achieved subject to completion of an online symptom questionnaire (and example of which being described by reference to blocks 202-206.

Blocks 202-204 represent a three stage interview process, whereby each stage includes a cyclic processes. This arrangement provides an efficient means for collecting medical information relevant to a patient, and provides additional efficiency from a computer implementation perspective given that templates and rules are able to be defined respectively for each cycle, allowing convenient extensibility for development over time. The stages are as follows:
A symptom-centric interview process 202. This enables the user to input details regarding symptoms underlying the appointment being made. In overview, the user is presented with a cyclic data input process which systematically gathers information regarding symptoms (with each new symptom starting a new cycle). A detailed example is provided in FIG. 2B.
A medication-centric interview process 203. This enables a user to input details of medications currently being taken, and a detailed example is provided in FIG.2C.
A problem-centric interview process 204. This enables a user to input details of medical problems (for example existing/known conditions), and is driven primarily based upon medications inputted at process 204, and secondarily via a freeform process. A detailed example is provided in FIG. 2D.

The layering of these cyclical processes assists in staggering information gathering in a prioritised manner, such that if a user is to become frustrated with the time it takes to complete the entire process, there is a high probability that at least the most important information is collected (for example symptom-centric interview process 202). Furthermore, data collected via processes 203 and 204 is stored against a user record, such that it need not be re-entered on a subsequent occasion. That is, system 130 maintains, for each registered user, details from historical interactions, including medication and problem data. Data entered via processes 202, 203 and 204 may be modified and updated on subsequent iterations at separate time points by the user, the result of which is described in a technical brief output to the consultant.

Functional block 205 represents a process whereby other interview items are presented via the web interface, and completed by a user. Examples of such other items are provided further below.

Following block 205, method 200 splits between a appointment scheduling process at block 208 (which coordinates the scheduling of an appointment with the relevant doctor/practice using appointment booking module 136), and submission of response data (i.e. data collected via interview processes 202-205) at block 206. The submitted data is processed by system 130 thereby to update the user's records, and to enable generation of a technical brief at block 207.

The technical brief is, in some embodiments, generated by response processing modules 137, which apply a predefined algorithm thereby to automatically generate a technical brief for a consultant (being a medical consultant in this embodiment). The technical brief is preferably a text-based file, drafted automatically in plain technical language (using standardised sentence structures defined by the algorithm) which is provided to the relevant medical practitioner (via any of a range of potential communications means) thereby to inform the medical practitioner regarding the patient and reasons for the appointment that has been booked. This enables the medical practitioner to more effectively deal with patients (as compared with an in-person interview process at the commencement of an interview) and additionally assists the doctor in preparing a report regarding the appointment (with the technical brief providing language and text that may be conveniently leveraged for that process). The technical brief generation process is described in additional detail further below.

### Exemplary Symptom-Centric Interview

As noted, FIG. 2B illustrates an exemplary symptom-centric interview process 202. In overview, the general crux is to provide a cyclical interview interface whereby a user inputs details regarding one or more symptoms being experienced, these being symptoms relevant to an appointment that is being scheduled with a medical practitioner.

The term “symptom” is used in a descriptive manner, and can at a practical level also be considered as a “medical problem”. For example, a symptom may be described as “chest pain” (being a symptom in the usual sense of the work) or “gout” (which may be considered as a medical problem as opposed to a symptom). The use of the term “symptom” should not exclude from the scope of embodiments the potential for user input to be described in terms of medical problems as opposed to “symptoms” in the pure sense of the word.

Functional block 211 represents the commencement of a process for a next symptom (this being a return point for each cycle). A symptom/problem selection interface is presented at 212. This interface may include any one or more of the following GUI components:
A text entry object, which enables a user to type a symptom name. This may be combined with a search functionality (for example a plurality of known symptoms are identified based on a database query based upon the user's input), an auto-complete functionality (similar to a search, but with suggestive results being automatically displayed during typing), and other such techniques.
An image-based selection object, for example using an image of a human body, enabling a user to designate a location for the symptom/problem. This may optionally include multiple zoom/detail levels, thereby enabling additional specificity in identifying body parts.
Drop-down menus and the like, with tiered levels (for example symptom type, location, etc).

Preferably these are used in combination. For example, an image-based selection object may be used as a pre-filter for the purposes of identifying possible symptoms (which may in turn enhance operation of an auto-complete process in a text entry object). Conversely, the image-based selection object can be used to enhance symptom information inputted by the text entry object (for example “pins and needles” can be enhanced with a precise location of the symptom).

In one embodiment, the image-based selection object enables for multi-tier selection, thereby to allow input identifying more detailed attributed of symptom location. For instance, this may be used to enable a user to graphically identify where a symptom is centred and where it may go (i.e. localisation and radiation). This location data is translated into a medical body part description and is then output in the technical brief in a similar way. “The patient indicates the [symptom name] is centred around the x region, with radiation to the y and z regions”. (where y and z are anatomical body regions).

Using the one or more objects in the symptom/problem selection interface, a symptom is identified from a set of known symptoms. Each symptom is associated with a template, which guides the remaining questions/prompts/objects displayed in the remainder of the process cycle based on that symptom. In this regard, templates may have ranges of specificity, from very generic templates (for example one to cover all forms of muscular pain) to specific templates (for example one that specifically relates to blurred vision). There may additionally be selection objects to specify characteristics such as “dizziness”, “numbness”, and so on. Additional templates may be defined, associated with symptoms, and added to the system over time. These may optionally incorporate rich GUI elements, including Flash objects and the like. These details are collected as represented by functional block 213.

Based on the symptom entered, the template may identify possible reliefs symptom will be shown, and enquire whether these have been tried and/or successful. Likewise, the interface may also seek input regarding exacerbating conditions, and/or a set of questions asking about possible treatments for the symptom.

Functional block 214 represents a symptom timing selection process. In one embodiment there are four different patterns of symptom timing:

episodic;

continuous;

continuous with episodic exacerbations; and

single event.

Additional detail such as frequency, duration, change in frequency recently are shown may be presented for episodic (i.e. the first and third patterns above). For “continuous”, a “is it worse at particular time” selection interface may be provided. For “single event”, a duration of episode selector is provided in place of a frequency selector.

Other non-template items may be dealt with at 215 (i.e. other interview items, for example questions, that are generic to all symptoms may be incorporated into the process at 215). Then at decision 216, a determination is made as to whether additional symptoms/problems are to be entered (in which case the process loops to 211), or whether process 202 is complete (as represented by block 217). Further, a client may determine to not proceed with a particular symptom/problem at this juncture and not iterate through the associated template. This information is transmitted in the technical brief.

### Exemplary Medication-Centric Interview Process

As noted, FIG. 2C illustrates an exemplary symptom-centric interview process 203. In overview, the general crux is to provide a cyclical interview interface whereby a user inputs details regarding one or more medications that are being taken, and these are associated with health problems being treated by those medications.

Functional block 221 represents the commencement of a process for a next medication (this being a return point for each cycle). Input is entered via a text entry object and, at 222, a predictive process is performed by reference to a medication database thereby to allow predictive auto-complete (and/or alternate forms of verification of an intended medication). Medication input completes at 223, at which point a medication that exists in medication database 134 has been selected.

Functional block 224 represents a process whereby possible health problems are determined for the selected medication. This is achieved using database 134, and optionally a separate translational database, which maps “technical” health problem descriptors in database 134 with “common” or “plain language” health problem descriptors. For example, the technical term “hypertension” is mapped to common term “high blood pressure”. In this manner, a user who selects a medication known to treat hypertension may enter the health problem as “high blood pressure” (or, should they prefer to use the technical term, as “hypertension”). User selection of a health problem occurs at 225, and may achieved using a range of GUI elements (drop down menus, auto-complete text, and so on).

Once a medication and symptom are selected, these are used to update user data (both for the current appointment, and for their ongoing medical records). Users are able to subsequently use a process similar to process 203 to update their medications over time.

Decision 226 represents an option provided to a user to input details for a further medication. In this regard, the method either loops to 221, or completes at 227.

### Exemplary Problem-Centric Interview Process

As noted, FIG. 2D illustrates an exemplary symptom-centric interview process 204. In overview, this process enables collection of data regarding existing medical problems. This is distinguished from method 202 in that method 202 relates to symptoms being experienced which give provide impetus for an appointment being booked, whereas method 204 relates more generally to known medical problems of the user. Method 204 is split into two cyclical sub-processes: one sub-process relating to problems identified via method 203, and another sub-process allowing freeform entry of problems.

Block 231 represents a process whereby a list (or other means of identification) of problems is presented to the user, based on medications and problems entered via method 203. In overview, each iteration of this cyclical sub-process relates to one of these medication/problem combinations.

If, at decision 232, it is determined that there was a previous treatment known to system 130, a pop-up or other object may be included to provide more specific questions regarding the previous medication/treatments.

The problems entered are be mapped onto a medical diagnosis, e.g. “high blood pressure” maps to “hypertension”; heart attack and “heart disease” maps to “ischaemic heart disease”. As represented by block 233, data indicative of management is obtained, for example using generic selectable identifiers, for example “usually well controlled”; “reasonably well controlled”; “not well controlled”; and “recently poorly controlled”. Templates may also be used for specific problems to provide more specific questions. For example, in relation to diabetes questions may be provided relating to eye checks, feet check, dietician reviews, and so on.

Functional block 235 represents a process whereby the user selects a treating doctor for each problems (e.g. an endocrinologist for the diabetes). This may allow cross referencing of patient follow up notes between doctors. In some cases doctors/practices are presented in the form of a pre-populated list and/or search facility. Functionality for enabling an invitation process (block 217) may be provided whereby a doctor/practice unknown to system 130 is nominated by the user and subsequently contacted (for example by email) with an invitation to register.

In some embodiments a “family history input” step (block 236) is included thereby to obtain family history information for medical problems. However, in other embodiments this is omitted, and family history optionally dealt with via a separate cyclical process (optionally performed only for problems where family history information is tagged as desirable, for instance via problem-specific templates).

The method loops at 237a thereby to enable a user to work through all medication-derived problems. Once that is complete, the method progresses to 238, where a freeform interface is presented thereby to enable inputting of a problem not associated with a treatment medication. The method then proceeds with steps similar to those considered above, with a further loop option at 237b and completion at 239. Steps 237 and 238 may be presented to the user simultaneously.

### Exemplary Registration Processes

FIG. 2E illustrates an exemplary user registration process 201b. In overview, a user commences the registration process at 241, inputs personal information at 242 (such as same, age, address, and so on), inputs insurance/healthcare details at 243 (for example Medicare in Australia), selects a doctor/practice at 244, and engages in a generic medical questionnaire at 245.

The selection of a doctor/practice at 244 may be pre-populated, in the event that registration is triggered via a referral hyperlink defined for a specific doctor/practice (which may be sent by email). Alternately, the user may either select a doctor from an available group (which may be preferably filtered based on criteria such as location) or, in the event that the desired doctor/practice is not shown, nominate that desired doctor/practice thereby to trigger a invitation process 247 (by which the doctor/practice is contacted and invited to register to use system 130). It will be appreciated, however, that appointments may only be placed with doctors/practices that are registered to integrate with system 130.

In terms of doctor/practice referrals, these are managed by various approaches between embodiments. For example:
In some embodiments doctors register individually, and associate themselves with practices.
In some cases practices register individually, and name their available doctors.
In some cases a unique registration is made for each doctor/practice combination.

Preferably the system is configured to enable updating to account for movement of doctors between practices.

For doctor/practice referrals, it is necessary to obtain data indicative of the EMR System that is used (for example PracSoft, Best Practice, Genie) and what software is being used to manage bookings (which may in some cases be the EMR software). This enables system 130 to integrate with the IT systems of the doctor/practice for the purpose of providing information and/or making bookings. In some cases this requires a software download at the doctor/practice system end, and/or date indicative of the static IP address (and in some cases API tokens/keys) for the IT systems of the doctor/practice.

Other information obtained during doctor/practice information may include practice types and specialities. In some cases this enables system 130 to handle varied forms of medical practice differently, for example including general practices as opposed to specialists and surgeons, with optional further extensions to the likes of physiotherapists, dentists, optometrists, chiropractors and the like.

### Overview of Translation Processes

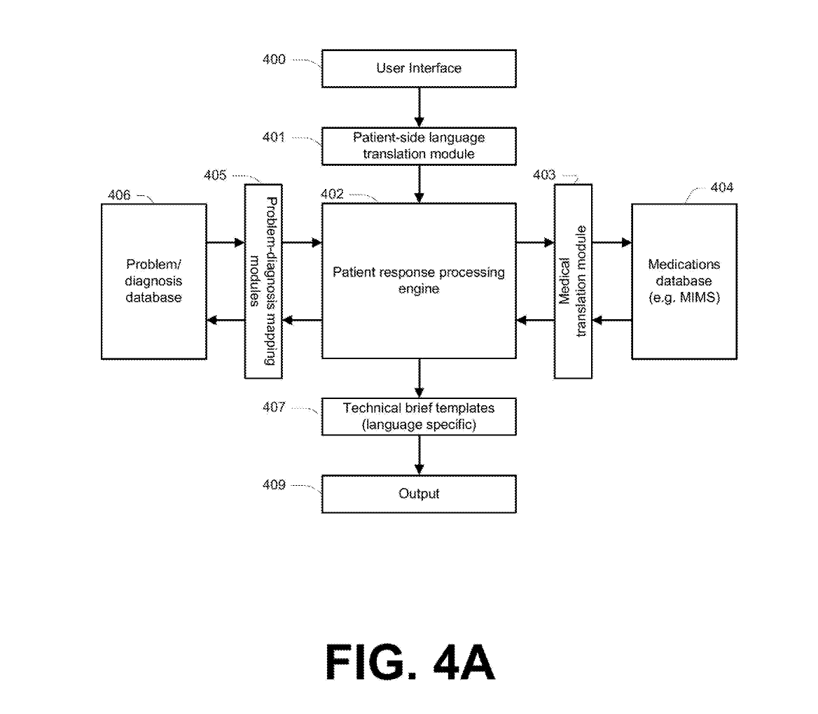

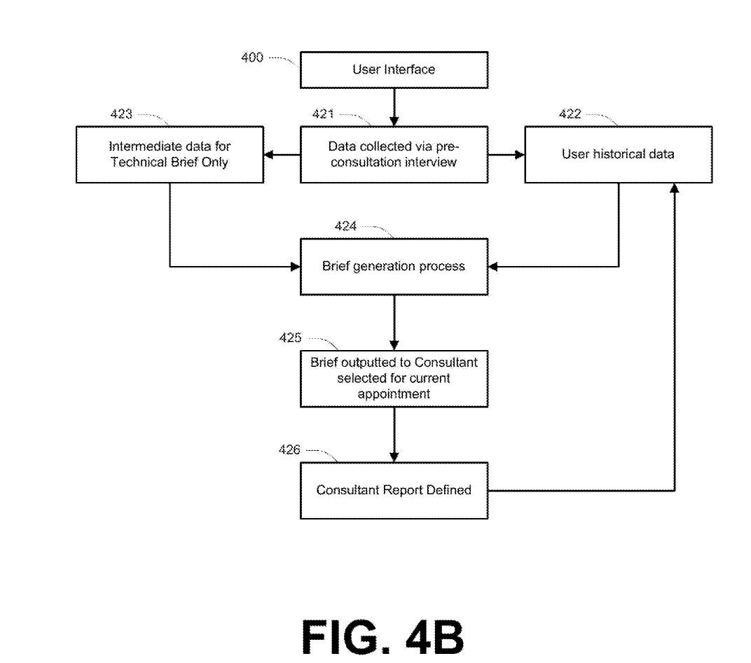

System 130 is configured to implement a number of translation processes, as schematically illustrated in FIG. 4A. In some embodiments only a subset of these are present. For example, either or both of the following foreign language translation processes may be present:
User-side language translation. For example, user interface 400 may be presented in multiple languages, depending on user preferences (for example English, German, French, Japanese, etc). Input received via user interface 400 is translated into a “core” language (for example English) by a patient side language translation module 401, such that patent response processing engine 402 need only operate in that core language.
Consultant-side language translation. By using language-specific templates 407 (or alternately another language translation functionality) thereby to output a technical brief (via output 409) in a language selected by a consultant (being a medical practitioner in the majority of embodiments described herein). In this manner, a consultant receives a technical brief in a preferred language.

The above language translation functionalities remove language barriers between users and consultants. For example, a user may participate in pre-consultation interviews in a first language, which are processed by engine 402 in a second language, and used as a basis for a technical brief in a third language. Such language barrier elimination is especially useful for travellers requiring medical assistance; it enables a doctor to receive relevant medical context from a patient in spite of the fact they are unable to converse.

Some embodiments also use translations between “common language” and “technical language”. As noted, the pre-consultation interview preferably provides a translation mechanism between language conventionally used by the general public and technical language preferred by a consultant. A specific example is provided in the context of FIG. 4A, where a medical translation module 403 interposes engine 402 with a database that uses technical language (in this case being a medications database 404). Module 403, by way of example, provides mapping between common language terms and technical terms. Accordingly, technical terms in the database are able to be reconciled with common language for the purposes of engine 402. This enables a user to interact with interface 400 using common language (if they so choose) but the technical brief to nevertheless use technical language.

FIG. 4A additionally illustrates a problem-diagnosis mapping module 405 which operates in conjunction with a problem/diagnosis database 406 thereby to enable engine 402 to automatically diagnose problems based on user input.

### Exemplary Technical Brief Generation Process

As noted, various embodiments described herein incorporate a method including processing received user response data thereby to generate a technical brief, the technical brief including a string of sentences defined based upon the received user response data.

Generally speaking, the technical brief is generated based upon responses inputted by users in response to particular stimuli (e.g. questions). For example, if the user selects responses b, d and e for a question, a corresponding output mapped as a technical translation for a technical brief (b′, c′ and e′) may be of the form: “In terms of [technical symptom description], Mr X indicates b, c′ and e′.”

In some embodiments, when questions have not received any answer at all, these are added to a list of what is termed “relevant negatives”. At the generation of the technical brief, these are included in the format. “In terms of relevant negatives, these include a, b, c, and d.” For example, when related to a headache symptom, . . . “Relevant negatives include migrainous symptoms, focal neurological symptoms and systemic symptoms”. (which are question sets for which the user did not make a single positive response, presented in the technical brief to inform that questions were asked without a positive response, of utility in a diagnostic setting)

An exemplary process 207 for generating a technical brief is illustrated in FIG. 2F. It should be appreciated that this is exemplary only, and various other methods/variations may be implemented in further embodiments. However, in preferred embodiments, the following key characteristics are observed:
User responses are obtained without requiring input or understanding of technical terminology.
The technical brief is phrased using technical terminology.
A set of rules is defined for defining and combining sentences using fields defined based on the user response data combined with sets of predefined linking text portions.

FIG. 2F is illustrated in a manner that is not limited to application in the context of technical briefs for medical practitioners in the context of a medical consultation (i.e. it could be applied across a range of consultation types), however it is described by reference to the medical example.

In FIG. 2F block 260 represents a process including identifying user response data. This may include both data procured subject to an immediately-preceding interview process, and data collected during previous interview processes. For example, data collected during the symptom-centric interview process (202) is relevant proximately only to a current appointment (but will be modified appropriately proximate to the next appointment), whereas data collected from the medication and problem centric processes (203 and 204), along with data gathered at 201b (such as allergies, and the like) is of relevance to a current and future appointments. In some cases block 260 is simply defined by identifying the relevant user (for example by way of a user ID) thereby to facilitate subsequent database queries used to extract data.

Block 261 represents a process including identifying brief preferences for the relevant consultant. In this case, the “relevant consultant” is a consultant with which an appointment is being booked. In this regard, a consultant may define a set of preferences relating to the content and structure of a brief that is prepared for them. The nature of such preferences varies between embodiments, and some examples are provided below:
Language. The consultant may, in some embodiments, specify a language (for example English, Japanese, German, etc) in which a brief is to be defined.
Structure: The consultant may, in some embodiments, specify a brief structure from a set of available structures. For example, each structure may differ from others in the context of ordering of information, and manner of presentation. As a specific example, one structure may include medications and problems in table form at the bottom of a page, whereas another includes the same information as bullet point sentences.
Content: The consultant may, in some embodiments, specify content that is to be included. This allows a consultant to customise between an extremely comprehensive brief, and a summary brief. For example, in some cases a medical practitioner may elect not to receive information regarding all current medications.
Delivery format: In some embodiments, a delivery format is determined by reference to stored data relating to a consultant's local IT systems, for example in the case of a medical practitioner this may relate to the practitioner's EMR system. This may determine the form of file that is outputted, and in some cases result in special delimiters and the like being incorporated into a file thereby to enable that file to be parsed and meaningfully read by a specific software application.

Block 262 represents a process including execution of a brief generation algorithm. In overview, depending on consultant preferences, generation of a brief is achieved by implementing an algorithm (i.e. a set of rules applied by a computer). This may be an algorithm associated with a specific template identified based upon the consultant's preferences. An example of such an algorithm is provided by reference to blocks 261a to 261e which is described below.

A next sentence structure is identified at 261a. The algorithm is defined by a plurality of ordered sentences, each having a structure defined by:
One or more data fields associated with the user (for example from interview response data). For example, a data field may be a medication, a symptom, a symptom trigger, a symptom exacerbating condition, and so on.
One or more linking portions. The linking portions may include set linking portions (i.e. the same each time the sentence is defined) or variable linking portions (i.e. varying either randomly or based on other conditions). For example, a variable linking portion might be defined by a selection between “as far as”, “in terms of”, in so far as”, or “from the viewpoint of”.

The required fields are extracted from user response data at 261b, and where necessary normalised and/or translated at 261c. For example, in terms of normalisation, the data field may include layman's terms language, which is normalised into technical language (alternately this normalisation may be performed prior to storing of the data as part of the interview process). In terms of language, data is stored in a core language, and may need to be translated into a different language depending on consultant preferences.

Linking portions are then selected at 261d, in the case of variable linking portions. The sentence is then compiled at 261e, and added to a file. The method then loops to 261a for a next sentence, with looping continuing until the brief is complete (based on rules defined for the algorithm).

Returning to the main portion of process 207, a brief file is outputted at 263, and exported to a consultant at 264. The nature of the file and the manner by which it is exported varies depending on preferences/characteristics of the consultant, for example the IT systems they implement (such that, where relevant, the brief can be received and imported into those IT systems). In one embodiment, IT systems integration is achieved such that the brief is associated with a user is accessible to a consultant either via a practice management software application (for example an EMR system or appointment booking system) in a manner associated with the user and/or appointment.

By way of a very simple example, a technical brief may have a form as shown below:
Patient is a [age field] year old [gender field] presenting with [symptom name field].
The [symptom name field] is [recurrence field] and is [linking portion 123] at [time field].

In so far as migrainous symptoms are concerned, the patient experiences [list of symptoms, appropriately separated including “,” and “and”]. In terms of localisation of symptoms is concerned, these are located in the [translation of location selected by user on body diagram interface map, separated by “,” and “and” as appropriate].
Patient is currently using [current medication field 1] for treatment of [problem associated with current medication field 1] and [current medication field 2] for treatment of [problem associated with current medication field 2].
Patient is allergic to [allergy fields] and has a family history of [family history fields separated by “,” and “and:” as appropriate].

In some embodiments, the brief is used as a basis to enable the consultant to prepare a report regarding an appointment. This may be achieved by, for example:
Enabling the consultant to copy and paste information from the brief into a consultation report.
Preparing a draft consultation report based on a process similar to process 207, and enabling the consultant to modify and finalise that report (optionally in the consultant's existing IT systems). For example, the consultant performs an existing process to commence generation of a report for an appointment, and it is pre-populated with data supplied by system 130. For example, this may be achieved using approaches described by reference to FIG. 1A, including a client-side plug-in that provided additional integration functionality to practice management software.

In this regard, in some embodiments the generation of a brief also includes elements of automated diagnosis based on processing of a user's response data. For example, as shown in FIG. 4A, module 405 and database 406 enable mapping of problems/symptoms to diagnosis data, based on a set of rules defined based on objective medical knowledge.

### Centralised Management of Medical History Data

FIG. 4B provides a schematic view of data flow arrangements according to one embodiment. This shows, in broad terms, how system 130 enables centralised management of medical history data.

Users interact with system 130 via a user interface 400 which, as noted, may be a web-base interface rendered in a browser application executing at a client device. Data 421 collected via a pre-consultation interview (conducted via interface 400) is used to update a database of user historical data 422 (which may be leveraged for future appointments and/or other purposes) and intermediate data 423 (which is used solely for the purposes of a current appointment).

A brief generation process 424 (for example based upon that of FIG. 2F) leverages both data 423 and data 424, and outputted to a consultant at 425. Relevantly, at this juncture it will be appreciated that the brief outputted to the consultant includes historical data 422 which was not necessarily collected for the purposes of that consultant. Rather, historical data 422 is reflective of a range of data which may have been collected over time in relation to a plurality of appointments (optionally with different consultants), thus defining a form of medical history. By this arrangement, should a patient move between doctors and/or medical practices, their historical information is inherently transferred by way of the next technical brief prepared for an appointment.

Furthermore, as indicated by block 426, the embodiment of FIG. 4B enables return data transfer from a consultant back to data 422, such that data from a consultant report or the like adds to the user's historical data.

In some embodiments, user historical data 422 is used for additional purposes. For example, data is able to be viewed and/or queried in a “de-identified” manner, whereby patient identifying information is hidden, but other data made available. This may be used, by way of example, to enable statistical analysis into the use of particular drugs for particular problems across a segment of society that makes use of system 130.

### Appointment Booking Algorithm

As will be appreciated from the disclosure herein, a primary focus for various embodiments based around system 130 is centralisation of appointment booking for consultants. This is preferably achieved by associating with each consultant data indicative of their current appointment booking software (including a static IP or the like), thereby to facilitate communications between system 130 and that software. Preferably, an individual appointment booking algorithm is defined for each form of software. For example, algorithms may operate as follows:
An algorithm which queries remote third party appointment calendar based on a user time-based query, and locks out appointment times for possible booking (i.e. those times are set to a “booked” state). One a booking is made (or not made), unused times are set to an “unbooked” state.
An algorithm which is able to monitor, in real time, a remote third party calendar thereby to extract and present substantially live availabilities, and book available times responsive to user commends.

It will be appreciated that appointment booking module 136 of system 130 may be configured to operate with a plurality of different third party booking engines and/or local appointment management applications, for example via APIs or the like. System 130 centrally manages data processing modules that facilitate such operation thereby to allow users of system 130 to book appointments via a common interface with a range of consultants that operate different booking software/procedures (which are typically accessed via separate different interfaces).

### Referral Management System

In some embodiments one consultant may refer a user to a second consultant. For example, in the medical field, this may be a GP referral to a specialist or surgeon. However, similar approaches are also present in other fields. In some embodiments system 130 is configured to manage such referrals. This may include either or both of the following:
Enabling a consultant to prepare a referral letter using their own existing IT systems, and that letter being exported via an automated process to system 130, where it is recorded along with the user's historical data.
Preventing a user from making an appointment with certain consultants unless a referral is present (for example a referral data field value associated with user.

In this regard, one embodiment provides a computer-implemented method for facilitating booking of medical appointments, the method including: providing an interface configured to enable a user to book a primary appointment with a selected medical practitioner from a first group of available medical practitioners; enabling the selected medical practitioner to provide input indicative of a referral to a specialist medical practitioner; and in response to the input indicative of the referral, configuring the interface thereby to enable the user to book a secondary appointment with the specialist medical practitioner.

More generally, another embodiment provides a computer-implemented method for facilitating booking of medical appointments, the method including: providing an interface configured to enable a user to book a primary appointment with a consultant from a first group of available consultants; enabling the selected consultant to provide input indicative of a second consultant not belonging to the first group of consultants; and in response to the input indicative of the referral, configuring the interface thereby to enable the user to book a secondary appointment with the second consultant.

### Consultation Follow-Up Functionalities

In some embodiments, following an appointment booked via system 130. For example, when a user logs into system 130 following a consultation, they are presented with an interface that presents follow up questions in regards to their progress since the last consultation. This may be template-driven based on either or both of:
Templates defined for issues (for example symptoms in the case of a medical consultation) to which the consultation relates; and
Rules defined for processing return output from a consultant, for example a consultation report generated by the consultant.

In an exemplary embodiment, the follow up questions loop through each of the listed symptoms defined for a medical consultation, to update any progress or changes to the symptom. These questions may be generic regarding timing variables and intensity characteristics or specific as predefined in the database. Additionally, the user is able to “close” a symptom (i.e. mark as inactive), if it has subsided. If the patient has chosen a new doctor, they will be able to select if previously listed symptom is relevant to a newly selected doctor.

### Voice Based Interview Technology

Throughout the disclosure, there is reference to the conducting of an interview process, based on the delivery of interview stimuli and processing of responses.

In some embodiments the stimuli are graphical (for example based on text and/or images rendered on a user device screen), and responses are inputted using the likes of input fields, check boxes, pull down menus, and other objects common to graphical user interfaces.

In further embodiments, a user interface is configured to enable input of responses via voice recognition. This is preferably combined with a user interface component configured to audibly deliver interview stimuli audibly. This enables the interface to provide a simulated verbal interview process, whereby stimuli are delivered audibly and responses received via voice recognition.

In further embodiments, the interview process consists of verbal output by an animated “avatar”, which graphically simulates an interviewer, with speech to text or voice recognition functionality to simulate the recording of the interview data.

Voice recognition is, in some embodiments, enhanced by reference to medical terminology databases, thereby to increase recognition accuracy in respect of medical terms (which are often mispronounced). For example, one approach includes identifying a set of terms as being anticipated for a particular response, and configuring a voice recognition engine to prioritise recognition of those terms when processing voice data provided in relation to that particular response.

Voice recognition in some embodiments involves a specific speech to text functionality whereby recognition is made with reference only to the specific set of predefined responses contained in the system as responses to each question, to further improve recognition accuracy.

Integration of Health Monitoring Data

In some embodiments, methods and functionalities considered herein are implemented in combination with functionality to obtain and process health monitoring data based on a set of predefined algorithms, thereby to enable automated determination of patient condition data.

In some cases the health monitoring data, such as heart rate, blood pressure, temperature, blood sugar, and so on, is manually inputted. In other embodiments connected monitoring devices are used, for example from connected heart monitors, blood pressure monitors, and the like). Device data may be obtained directly from the devices (for example via a wired or wireless connection to a client device), or from third party services which centrally manage data obtained from such devices.

In some embodiments, the input data is summarised prior to being presented in the technical summary to the consultant, including sorting into same time of day, sorting into day of week or sorting into averages or sorting into daytime and nocturnal averages or a combination of the above. The data may be presented graphically as sorted above or may be presented numerically.

### Exemplary Client-Server Arrangement

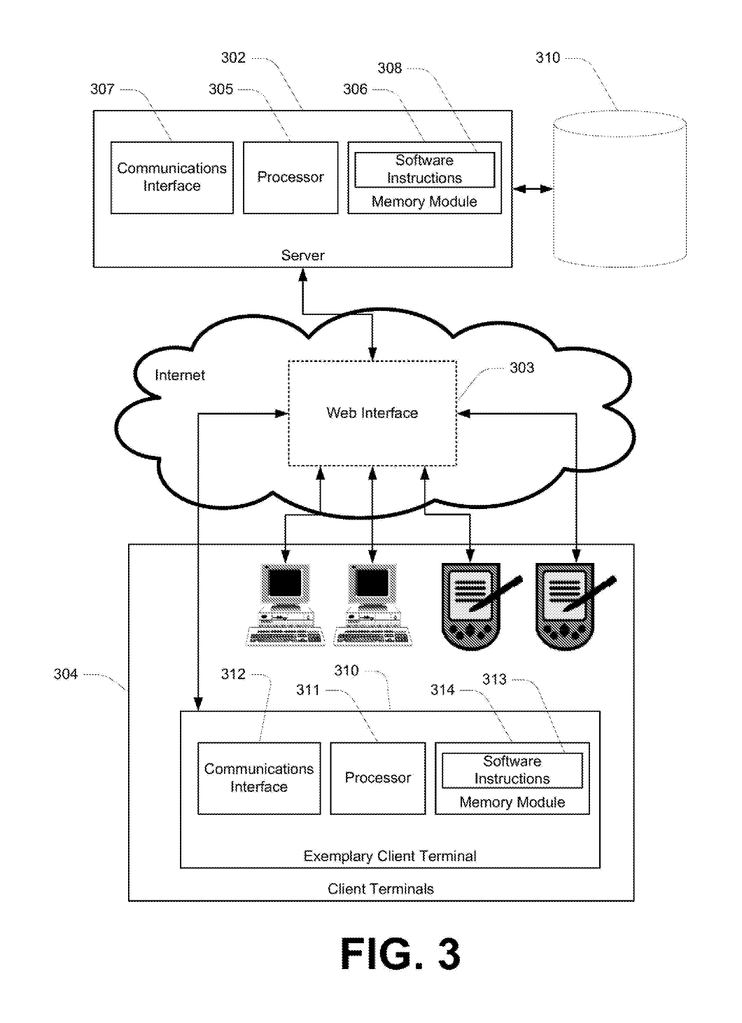

In some embodiments, methods and functionalities considered herein are implemented by way of a client-server arrangement, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant computer implemented methods, systems and frameworks configured for use in the context of pre-consultation information management.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for obtaining medical information from a user, the method including:
accepting, from the user, data indicative of a medication;
(ii) accessing an information repository thereby to determine a plurality of medical problems treated by the medication;
(iii) enabling the user to select one of the determined medical problems;
(iv) based on the user's selection of one of the determined medical problems, enabling the user to input further specific details of the identified medical problem; and
(v) generating a technical brief including details of the medication and a technical problem description for the selected one of the medical problems.

2. A method according to claim 1 including repeating (i) to (iv) for a plurality of medications, wherein the technical brief including details of the plurality of medications and technical problem descriptions for the respective selected medical problems.

3. A method according to claim 1 including, based on the selected one of the determined medical problems, presenting to the user a series of interview stimuli defined by a template associated with the determined medical problem.

4. A method according to claim 3, further including maintaining a central data record for the user, the central data record including details of medications and technical problems selected by the user.

5. A method according to claim 1 wherein (iii) includes enabling the user to select one of the determined medical problems based on a non-technical problem description.

6. A method according to claim 5 including querying one or more information repositories that collectively map medications to (a) medical problems based on technical descriptions and (b) medical problems based on non-technical problem descriptions.

7. A method according claim 1 wherein the technical brief is defined by a string of sentences in a selected language.

8. A computer implemented method for obtaining medical information from a user, the method including:
accepting, from the user, data indicative of a medication;
(ii) accessing an information repository thereby to determine a plurality of medical problems treated by the medication;
(iii) enabling the user to select one of the determined medical problems based on a non-technical problem description; and
(iv) based on the user's selection of one of the determined medical problems, enabling the user to input further specific details of the identified medical problem; and
(v) updating a database that maintains records of the user's medical history to reflect the medication, selected medical problem, and the further specific details.

9. A method according to claim 8 wherein (i) to (v) loop thereby to enable updating of the database for a plurality of medications and respective selected medical problems.

10. A method according to claim 9 including a step of generating a technical brief including details of the plurality of medications, for each medication, a respective technical problem description associated with the selected medical problem.

11. A method according to claim 10 including maintaining access to a first data source that maps technical problem descriptions to non-technical problem descriptions for a plurality of medical problems.

12. A method according to claim 11 including maintaining access to a second data source that maps medications to technical problem descriptions.

13. A method according to claim 12 wherein the second data source is used as the an information repository thereby to determine a plurality of medical problems treated by the medication, and the first data source is used to determine non-technical problem descriptions for presentation to the user.

14. A method according to claim 8 wherein the user is prompted to input additional information regarding the details of each selected medical problem.

15. A computer-implemented method for facilitating pre-consultation information management, the method including:
providing an interview interface configured to receive input data from a user in response to an interview process, wherein the interface is configured to deliver interview stimuli to the client;
(ii) operating an interview driving module thereby determine a sequence of interview stimuli to be delivered via the interface, wherein the sequence is affected by one or more responses received in respect of preceding interview stimuli;
(iii) maintaining a set of user response data derived from responses to the interview stimuli; and
(iv) processing the received user response data thereby to generate a technical brief, wherein the technical brief includes a string of sentences defined based upon the received user response data.

16. A method according to claim 15 wherein the interview interface is additionally configured to enable the user to select a consultant from a predefined list of consultants.

17. A method according to claim 16 wherein the interview interface is additionally configured to enable the user to book an appointment with a selected consultant.

18. A method according to claim 16 including operating an appointment booking module, wherein the appointment booking module is configured to interact with a plurality of consultant-side appointment management software modules respectively operated by the plurality of consultants.

19. A method according to claim 16 including determining communications data associated with a selected consultant, and delivering the generated technical brief to the selected consultant in accordance with the communications data.

20. A method according to claim 15 wherein the sequence of interview stimuli is delivered via a plurality of looped processes.

21.-53. (canceled)
